(19) United States
(12) Patent Application Publication
(10) Pub. No.: US 2007/0253148 A1
(43) Pub. Date: Nov. 1, 2007

(54) Printed wiring board, semiconductor package with printed wiring board and electronic device having printed circuit board

(75) Inventor: Kiyokazu Ishizaki, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/496,565

(22) Filed: Jul. 31, 2006

(30) Foreign Application Priority Data
Mar. 30, 2006 (JP) 2006-94878

(51) Int. Cl. H02B 1/00

(52) U.S. Cl. 361/600

(57) ABSTRACT

According to one embodiment, a printed circuit board includes an insulating substrate, a plurality of lands formed on the insulating substrate, a conductive wiring pattern coupled to the lands, a protective film covering the insulating substrate and having an opening larger than the outer profile of each of the lands, a plurality of bumps bonded to the lands and a circuit component electrically connected to the lands via the bumps. Each land has a land body having a gap along an opening rim of the opening, and an extension part extending from a part of the land body to the opening rim of the opening.

### CROSS-REFERENCE TO RELATED APPLICATIONS

This application is based upon and claims the benefit of priority from the prior Japanese Patent Application No. 2006-94878, filed Mar. 31, 2006, the entire contents of which are incorporated herein by reference.

### BACKGROUND

1. Field

Embodiments of the present invention relate to a printed circuit board, a semiconductor package installed on a printed wiring board and an electronic device having a printed circuit board, and more specifically to the land structure of the printed wiring board or the semiconductor package.

2. Description of the Related Art

An electronic device such as a portable computer, for example, includes a printed circuit board. A printed circuit board has a printed wiring board where conductive wiring patterns are formed on an insulating substrate, as well as a circuit component installed on the printed wiring board. A printed wiring board has a land, which serves as a connection terminal, at the edge or in the middle of each conductive wiring pattern. A circuit component is connected by means of a bump such as a solder ball. The surface of a printed wiring board has a protective film such as solder resist that covers the areas other than the lands.

Printed wiring boards offering higher share strength of solder balls are provided (refer to U.S. Pat. No. 6,448,504). The printed wiring board specified in U.S. Pat. No. 6,448,504 includes a land and pattern protection film. The pattern protective film has an opening that opens in the position where the land is formed. The diameter of this opening is set larger than the outer diameter of the land. The land has a reinforcing pattern extending outward from its outer periphery rim. The extension edge of the reinforcing pattern is covered with the pattern protection film.

A land has a conductive wiring pattern connected to it. Therefore, an attempt to bond a bump to a land inevitably causes a part of the bump to attach to the conductive wiring pattern. Because the sizes or number of connected conductive wiring patterns vary among individual lands, the area of conductive layer to which the bump is attached is different from one land to another. Especially in recent designs where lands are getting smaller, the area of conductive layer changes significantly in accordance with the sizes and number of conductive wiring patterns.

The shape of a bump bonded to a land is affected significantly by the area of conductive layer to which the bump is attached. For this reason, the bonded state of bump is also different among lands where the area of conductive layer is different. In other words, application of bumps of a standardized size to a plurality of lands may provide some properly bonded bumps, but other bumps may become poorly bonded.

For example, the reinforcing patterns specified in U.S. Pat. No. 6,448,504 are intended to improve share strength, and the purpose is not to provide a uniform bonded state of bump. In addition, allowing the reinforcing patterns to extend as far as to locations under the pattern protection film is not favorable in view of a narrower land pitch.

### BRIEF DESCRIPTION OF THE SEVERAL VIEWS OF THE DRAWING

FIG. 1 is an exemplary perspective view of a portable computer conforming to the first embodiment of the present invention;

FIG. 2 is an exemplary cross-section view of a printed circuit board conforming to the first embodiment of the present invention;

FIG. 3 is an exemplary cross-section view of a printed circuit board conforming to the first embodiment of the present invention;

FIG. 4 is an exemplary cross-section view showing a printed circuit board conforming to the first embodiment of the present invention without solder resist;

FIG. 5 is an exemplary cross-section view of the printed circuit board taken along line F5-F5 of FIG. 3;

FIG. 6 is an exemplary cross-section view of a printed circuit board conforming to the second embodiment of the present invention;

FIG. 7 is an exemplary cross-section view of a printed circuit board conforming to the third embodiment of the present invention;

FIG. 8 is an exemplary cross-section view of the printed circuit board taken along line F8-F8 of FIG. 7;

FIG. 9 is an exemplary cross-section view of a printed circuit board conforming to the fourth embodiment of the present invention;

FIG. 10 is an exemplary cross-section view of a bonded state of bump conforming to the fourth embodiment of the present invention;

FIG. 11 is an exemplary cross-section view of a printed circuit board conforming to the fifth embodiment of the present invention;

FIG. 12 is an exemplary cross-section view of a semiconductor package conforming to the fifth embodiment of the present invention; and

FIG. 13 is an exemplary cross-section view showing an example of modification of a pad conforming to any of the first through fifth embodiments of the present invention.

### DETAILED DESCRIPTION

Hereinafter, embodiments of the present invention are explained below according to a set of drawings showing how the embodiments apply to a portable computer.

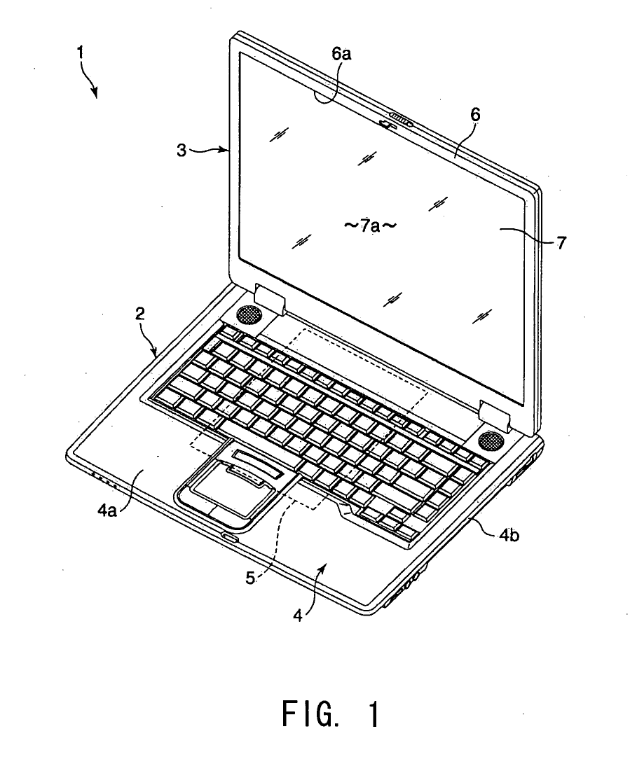

FIGS. 1 through 5 disclose a portable computer 1 being an electronic device conforming to the first embodiment of the present invention. As shown in FIG. 1, the portable computer 1 includes a computer body 2 and a display unit 3. The computer body 2 includes a box-shaped enclosure 4. The enclosure 4 includes a top wall 4a, side walls 4b, and a bottom wall that is not illustrated. The enclosure 4 houses a printed circuit board 5 inside. The printed circuit board 5 may be the main board of the portable computer 1 or a circuit board that causes a specific module to function.

The display unit 3 includes a display housing 6 and a liquid crystal display (LCD) panel 7 housed inside the display housing 6. The LCD panel 7 has a display screen 7a. The display screen 7a is exposed on the outside of the display housing 6 via an opening 6a provided on the front side of the display housing 6.

The display unit 3 is supported via hinge devices at the rear end of the enclosure 4. Therefore, the display unit 3 is rotatably movable between the closed position to which it moves in a manner collapsing onto the top wall 4a from above to cover the top wall 4a, and the erected position where the top wall 4a and display screen 7a are both exposed.

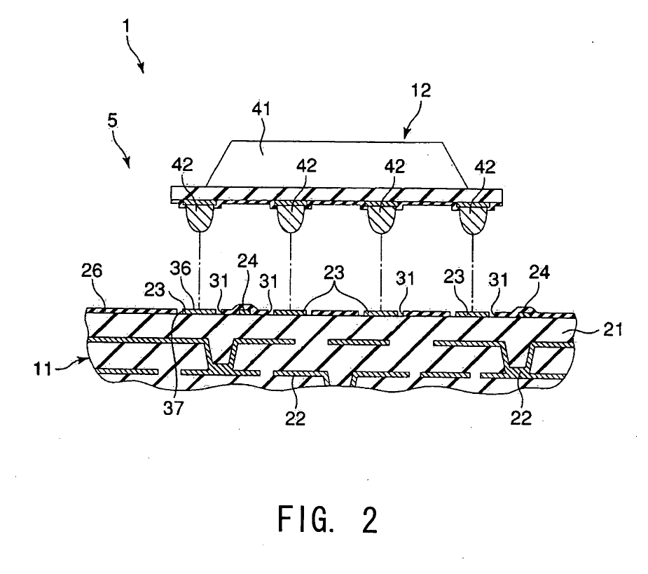

As shown in FIG. 2, the printed circuit board 5 conforming to the first embodiment includes a printed wiring board 11 and a circuit component 12 installed on the printed wiring board 11. In this embodiment, explanation is given using a BGA (Ball Grid Array) semiconductor package as an example of the circuit component 12. It should be noted, however, that the circuit component 12 is not at all limited to a BGA semiconductor package. For example, the circuit component 12 may be a semiconductor package of LGA (Land Grid Array) or other type, or an electronic component such as an IC chip or capacitor can also be used. The circuit component 12 can be selected from among a wide range of components as long as they can be mounted by means of bumps.

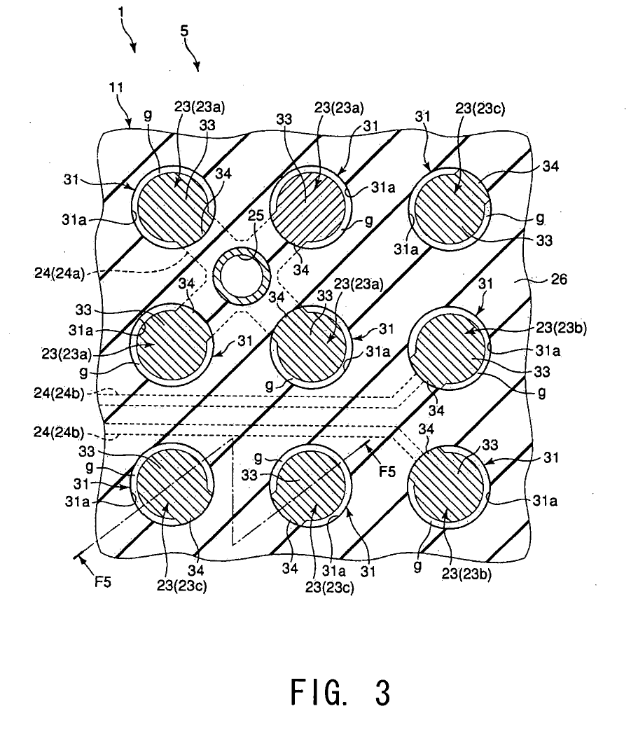

As shown in FIGS. 2 and 3, the printed wiring board 11 includes an insulating substrate 21, an inner layer 22, a plurality of pads 23, a plurality of conductive wiring patterns 24, a through hole 25, and a solder resist 26. The pad 23 is considered an example of land. The solder resist 26 is considered an example of protection film.

The insulating substrate 21 is formed by reinforced material such as glass fabric, into which another material with insulation property such as phenol resin, epoxy resin, polyimide or BT resin is impregnated. As shown in FIG. 2, the inner layer 22 is provided inside the insulating substrate 21. The inner layer 22 is a type of conductive wiring pattern and constitutes a part of the electronic circuit on the printed circuit board 5.

The pad 23 and conductive wiring pattern 24 are provided on the surface of the insulating substrate 21. The pad 23 and conductive wiring pattern 24 are formed by conductor material such as copper foil. As shown in FIG. 3, the pads 23 are arranged in a grid pattern, for example, and standardized in such a way that the pads 23 can be used with various circuit components.

The plurality of pads 23 are classified into first through third pads 23a, 23b, 23c based on the purposes for which they are used. The first pad 23a may be a power supply pad, for instance, that supplies power to the circuit component 12. The second pad 23b may be a signal line pad, for instance, that exchanges signals with the circuit component 12. In this embodiment, the third pad 23c is an idle pad that is not electrically connected to the circuit component 12.

The conductive wiring pattern 24 is connected to the pad 23. The conductive wiring pattern 24 may be an inter-pad connection pattern, for instance. The plurality of conductive wiring patterns 24 are classified into first and second conductive wiring patterns 24a, 24b based on the purposes for which they are used.

The first conductive wiring pattern 24a is connected to the first pad 23a. The first conductive wiring pattern 24a electrically connects the first pad 23a to the power supply. The second conductive wiring pattern 24b is connected to the second pad 23b. The second conductive wiring pattern 24b electrically connects the second pad 23b to other second pad 23b, for instance. The conductive wiring patterns 24 can have various widths according to the purposes for which they are used. For example, the first conductive wiring pattern 24a is wider than the second conductive wiring pattern 24b.

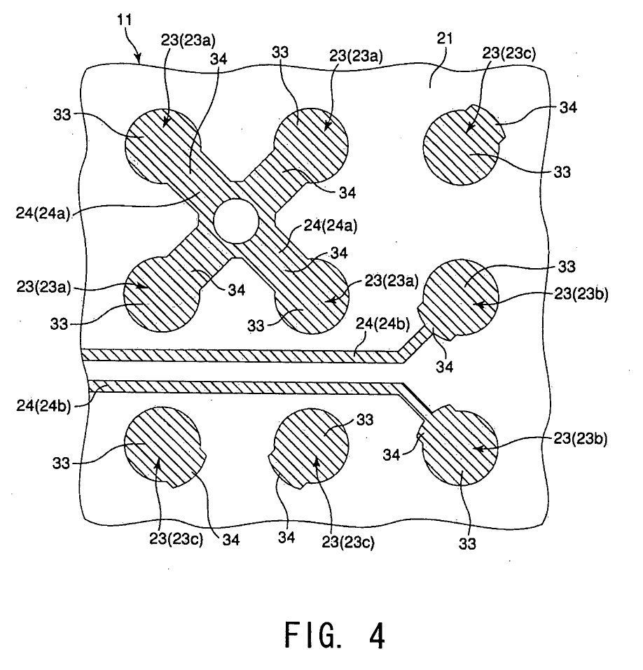

FIG. 4 shows the printed wiring board 11 without the solder resist 26. As shown in FIG. 4, the conductive wiring pattern 24 is integrally formed with the pad 23. For example, as shown in FIG. 3 the first conductive wiring pattern 24a is electrically connected to the inner layer 22 via the through hole 25.

As shown in FIGS. 2 and 3, the solder resist 26 is provided as the outermost layer of the printed wiring board 11. The solder resist 26 is provided over almost the entire surface of the printed wiring board 11, for example, and covers the conductive wiring pattern 24. The solder resist 26 has an opening 31 in a location corresponding to each pad 23. The opening 31 is formed slightly larger than the outer profile of the pad 23. In other words, the pad 23 is arranged within the opening 31 and exposed to the outside of the printed wiring board 11 via the opening 31.

Further, the pad 23 conforming to this embodiment is explained in details. As shown in FIG. 3, the pad 23 has a pad body 33 and an extension part 34. The pad body 33 is formed in a circular shape and has an outer diameter slightly smaller than the inner diameter of the opening 31. The pad body 33 is arranged in such a way that a gap g is formed along the opening rim 31a of the opening 31.

The extension part 34 extends from a part of the pad body 33 toward the opening rim 31a of the opening 31. The edge of the extension part 34 reaches the opening rim 31a and connects to the opening rim 31a.

The extension parts 34 of the first and second pads 23a, 23b are provided in a manner corresponding to the lead-out directions of the first and second conductive wiring patterns 24a, 24b, respectively. As shown in FIG. 3, the first and second conductive wiring patterns 24a, 24b are respectively connected to the edges of the extension parts 34. In other words, the conductive wiring pattern 24 is not arranged within the opening 31 in the solder resist 26, nor is it exposed to the outside via the opening 31. Instead, the conductive wiring pattern 24 is covered in its entirety with the solder resist 26.

That is to say, the pad 23 is formed in a shape conforming to the opening rim 31a in the solder resist 26 and has a groove (that is, a part where no conductor layer is provided) between a part of the pad 23 and the opening rim 31a.

As shown in FIG. 3, the pads 23 are arranged in such a way that their grooves (that is, gaps g) are aligned side by side. In other words, each extension part 34 is arranged by avoiding the line that connects the pad 23 to which the extension part 34 belongs and other adjacent pad 23 located closest to the pad. For example, in this embodiment the extension parts 34 of the plurality of pads 23 arranged in a grid pattern respectively extend to directions other than those toward other adjacent pads 23 in the same line or row.

The extension part 34 is also provided in the third pad to which a conductive wiring pattern 24 is not connected.

The pad area of each of the first through third pads 23a, 23b, 23c (that is, the area of conductor layer to which a bump is attached), is evaluated based on the total sum of area A of the pad body 33 of each pad 23 and area B of the pad's extension part 34 (A+B). In the printed wiring board 11, the extension part 34 of the first pad 23a, extension part 34 of the second pad 23b and extension part 34 of the third pad 23c all have the same area.

In other words, when the area of the first pad 23a (pad body 33, extension part 34) is given by (A1, B1), area of the second pad 23b (pad body 33, extension part 34) by (A2, B2), and area of the third pad 23c (pad body 33, extension part 34) by (A3, B3), then the equation A1+B1=A2+B2=A3+B3 works out. That is to say, the first through third pads 23a, 23b, 23c all have the same pad area.

Each conductive wiring pattern 24 is laid out in such a way that the gap g of a pad 23 to which the conductive wiring pattern is not connected is disposed between the conductive wiring pattern and the pad. In other words, a conductive wiring pattern 24 is drawn so that it runs alongside the gap g of a pad 23. It means that a conductive wiring pattern 24 is arranged in such a way that it does not run alongside the extension part 34 of a pad 23. For example, as shown in FIG. 3, the second conductive wiring pattern 24b is laid out so that it runs alongside the gap g of the first pad 23a.

As shown in FIG. 2, the circuit component 12 is installed on the printed wiring board 11. The circuit component 12 includes a package body 41. Bumps 42 are provided on the bottom surface of the package body 41. The package body 41 has semiconductor elements installed in it and is electrically connected to the bumps 42 via wires, for instance. The bumps 42 are arranged in a grid pattern, for example, and standardized together with the array of pads 23 on the printed wiring board 11.

For instance, there is no need to change the design of bumps 42 and pads 23 when changing the semiconductor elements installed in the package body 41 to elements of different types. In this embodiment, the bumps 42 corresponding to the third pads 23c on the printed wiring board 11 are not electrically connected to the semiconductor elements, but they remain idle instead. One example of bump 42 is solder ball. Note that the bumps 42 need not be always provided on the circuit component 12. For example, they are provided on the printed wiring board 11 in the case of a LGA package.

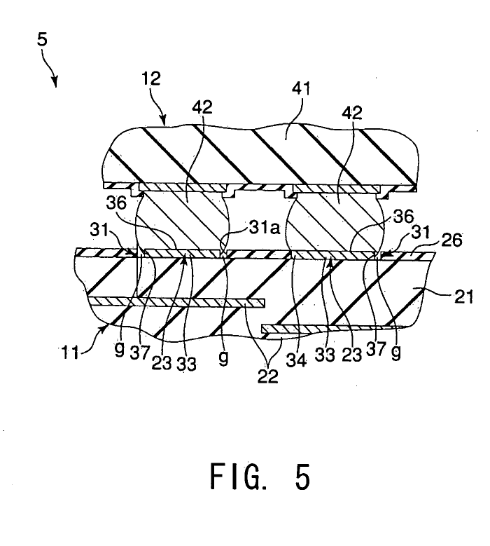

As shown in FIG. 5, each bump 42 is connected to a pad 23. A majority of the bump 42 is connected to the top surface 36 of the pad 23. A part of the bump 42 enters the gap g between the pad body 33 and opening rim 31a and is bonded to the peripheral surface 37 of the pad body 33. In other words, the bump 42 is bonded three-dimensionally to the pad 23. In this embodiment bumps are also bonded to the third pads 23c that are idle, in the same manner as they are connected to the first and second pads 23a, 23b. As the bumps 42 are connected to the pads 23, the circuit component 12 is electrically connected to the pads 23a, 23b via the bumps 42.

The operation of the portable computer 1 is explained.

All of the plurality of bumps 42 have the same size. In other words, the bumps 42 have a specified standard size that does not change according to the number or sizes of conductive wiring patterns 24 connected to the individual pads 24.

All of the plurality of pads 23 conforming to this embodiment have the same pad area regardless of the sizes or number of conductive wiring patterns 24 connected to the individual pads 23. As a result, the bumps 42 connected to the pads 23 have the same bonded state.

When the printed circuit board 5 of this configuration is used, the bonded state of each bump 42 with a pad 23 is affected to a lesser extent by the sizes and number of conductive wiring patterns 24 connected to the pad 23.

In other words, connecting a conductive wiring pattern 24 to a pad having a gap along the opening rim 31a in the solder resist 26 (that is, a pad that only has a pad body 33 in this embodiment) changes the pad area only by the area of the conductive wiring pattern.

The pad 23 conforming to this embodiment has an extension part 34 in addition to its pad body 33. In other words, the pad area is initially larger than the pad that only has its pad body 33. For this reason, change in the pad area by the area of the conductive wiring pattern translates to a smaller rate of change in the pad area compared to the aforementioned pad. That is to say, the pad 23 conforming to this embodiment provides a large initial pad area and thereby suppresses the rate of change in the area due to the effect of any conductive wiring pattern connected to it.

Accordingly, when bumps 42 having the same size are used for respective pads 23, the variation in bonded state among the pads 23 can be reduced. In other words, the bonded state of each bump 42 is affected to a lesser extent by the sizes and number of conductive wiring patterns 24 connected to the applicable pad 23. Because the bonded state of bump 42 does not vary much, the problem of non-connection (so called “unsoldered state”) or weak bonded state caused by deformation of bump 42 can be reduced, and a stable bonded state can be formed as a result.

When a gap g is provided between the pad body 33 of a pad 23 and the opening rim 31a, a bump 42 can be bonded three-dimensionally to the pad 23. In other words, the pad 23 conforming to this embodiment can form a more stable bonded state through improved bump bonding strength (share strength, for example).

When pads 23 are arranged in such a way that their gaps g are aligned side by side, it becomes possible to provide a sufficient pad area while maintaining at least a specified distance between the adjacent conductor layers. Specifically, providing an extension part 34 increases the pad area. However, if the extension part 34 extends in the direction toward other adjacent pad 23 closest to the applicable pad, then the conductor layer of this extension part 34 becomes very close to the conductor layer of such other pad 23. This is not favorable in view of a narrower pad pitch.

However, the distance between the conductor layer of an extension part 34 and the conductor layer of other pad 23 can be increased by means of forming a gap g (that is, a part where no conductor layer is provided) separately from the extension pad 34 and aligning these gaps g side by side. Thus, the plurality of pads 23 of a larger pad area can be arranged with a narrow pitch (that is, they can be arranged densely).

By allowing the conductive wiring pattern 24 to be connected to the extension part 34, the bonded state of each bump 42 is affected to a lesser extent by the sizes and number of conductive wiring patterns 24 connected to the applicable pad 23. For example, the conductive wiring pattern 24 conforming to this embodiment is entirely covered with the solder resist 26. In other words, the area of conductor layer connected to each bump 42 is not affected by the sizes or number of conductive wiring patterns 24. Because the pad area does not change, the bonded state between a pad 23 and a bump 42 remains almost uniform.

In particular, a uniform bonded state can be achieved among all pads 23 if the total sum of the area of the pad body 33 and the area of the extension part 34 is the same among all pads 23.

If the conductive wiring pattern 24 is laid out in such a way that it runs alongside the gap g, a clearance can be ensured between the conductor layer of the conductive wiring pattern 24 and that of the pad 23 even when the conductive wiring pattern 24 and pad 23 are arranged very close to each other. In other words, the conductive wiring pattern 24 and pad 23 can be densely arranged.

Each extension part 34 in this embodiment extends to the opening rim 31a. However, the extension part 34 need not always extend to the opening rim 31a. If this is the case, a part of the tip of the applicable conductive wiring pattern 24 is exposed within the opening 31. Each extension part 34 only needs to be provided in a manner ensuring an appropriate pad area, and its shape is not specifically limited. However, extending the extension part 34 to the opening rim 31a makes it easier to ensure a larger pad area. The bump 42 conforming to this embodiment need not be bonded three-dimensionally to the pad 23. Instead, the bump 42 may be bonded only to the top surface 36 of the pad 23.

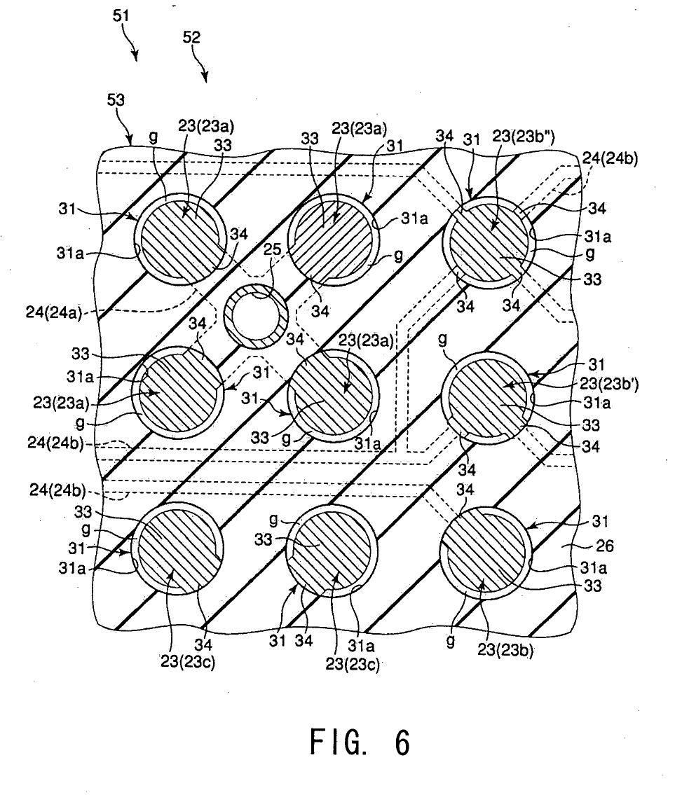

A portable computer 51 is explained by referring to FIG. 6, as an electronic device conforming to the second embodiment of the present invention. The parts of configuration having the same functions as the corresponding parts of the portable computer 1 conforming to the first embodiment are not explained, and they are indicated using the same symbols.

The enclosure 4 of the portable computer 51 houses a printed circuit board 52 inside. The printed circuit board 52 has a printed wiring board 53 and a circuit component 12 on which bumps 42 are provided. The printed wiring board 53 has pads 23 provided on an insulating substrate 21. The pads 23 on the printed wiring board 53 include a pad 23b to which one conductive wiring pattern 24 is connected, a pad 23b′ to which two conductive wiring patterns 24 are connected, and a pad 23b″ to which four conductive wiring patterns 24 are connected.

As shown in FIG. 6, the pad 23b′ has two extension parts 34, 34 arranged at a distance in between. The extension parts 34 of the pad 23b′ are arranged in locations corresponding to where the applicable conductive wiring patterns 24 are connected. The pad 23b″ has four extension parts 34, 34, 34, 34 arranged at a distance in between. The extension parts 34 of the pad 23b″ are arranged in locations corresponding to where the applicable conductive wiring patterns 24 are connected.

If one extension part 34 of the pad 23b′ has area B2′, one extension part 34 of the pad 23b″ has area B2″, and the pad body 33 of each pad has the same area A, then the equation B2=2×B2′=4×B2″ works out. In other words, the pads 23b, 23b′ 23b″ all have the same pad area.

When the printed circuit board 52 of this configuration is used, the bonded state of each bump 42 with a pad 23 is affected to a lesser extent by the sizes and number of conductive wiring patterns 24 connected to the pad 23, and a stable bonded state can be formed as a result. In other words, providing an extension part or parts 34 on the pad 23 reduces the rate of change in the pad area due to the effect of any conductive wiring pattern 24 connected to the pad. This makes the bonded state of bump 42 roughly uniform among individual pads 23.

According to the printed circuit board 52 conforming to this embodiment, conductive wiring patterns 24 are connected to extension parts 34 and therefore the area of each pad does not change due to the effect of any conductive wiring pattern 24 connected to it, and consequently a more uniform bonded state can be achieved. In particular, the bonded state becomes uniform among all pads 23 as long as all pads 23 have the same area, which is the case of this embodiment.

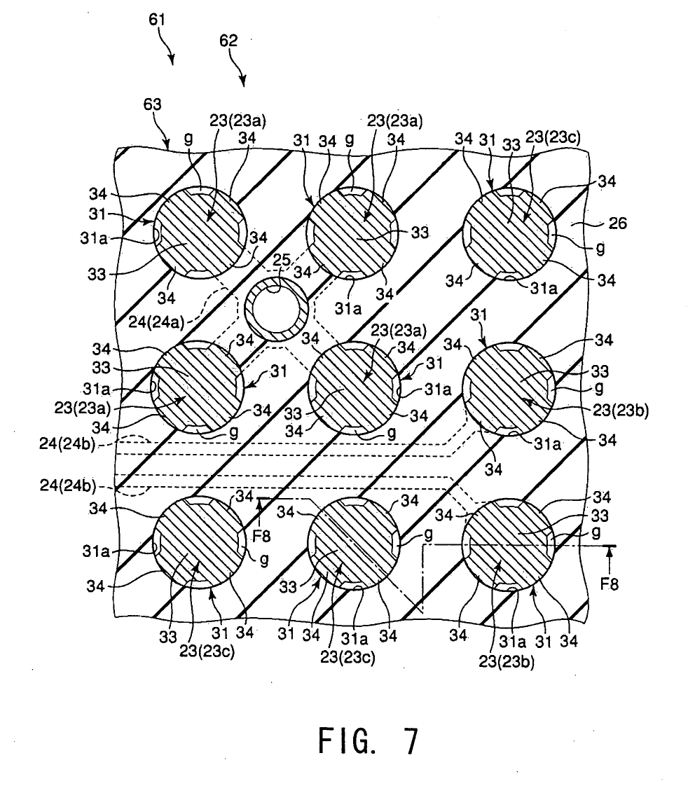

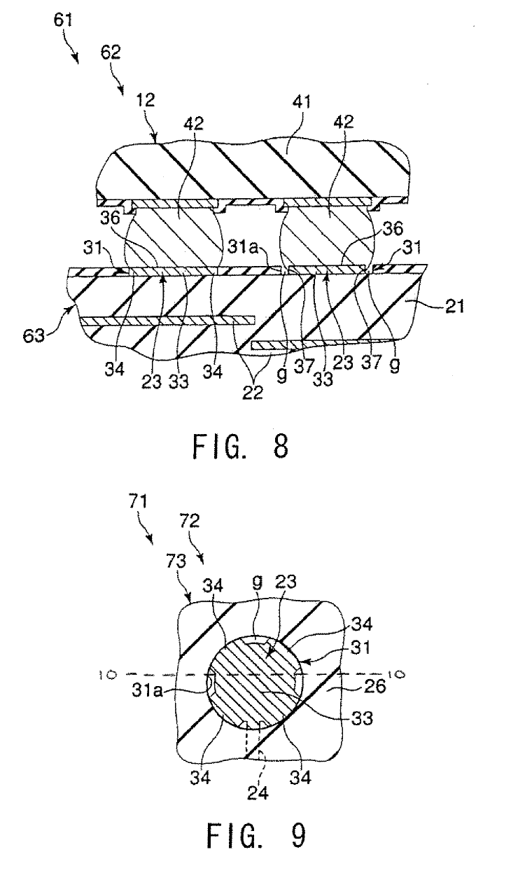

A portable computer 61 is explained by referring to FIGS. 7 and 8, as an electronic device conforming to the third embodiment of the present invention. The parts of configuration having the same functions as the corresponding parts of the portable computer 1 conforming to the first embodiment are not explained, and they are indicated using the same symbols.

The enclosure 4 of the portable computer 61 houses a printed circuit board 62 inside. The printed circuit board 62 has a printed wiring board 63 and a circuit component 12 on which bumps 42 are provided. The printed wiring board 63 has pads 23 provided on an insulating substrate 21.

As shown in FIG. 7, the pads 23 on the printed wiring board 63 include first through third pads 23a, 23b, 23c. The first through third pads 23a, 23b, 23c conforming to this embodiment have four extension parts 34, 34, 34, 34, respectively. The total sum of the areas of the four extension parts 34 of each pad 23 is the same among all pads 23.

The four extension parts 34 are arranged along the periphery of the pad body 33 at an equal interval from each other. The four extension parts 34 are provided in the directions in which conductive wiring patterns 24 will be led out. In this embodiment, some of the extension parts 34 are not connected to conductive wiring patterns 24 but remain idle instead.

As shown in FIG. 7, the pads 23 are arranged in such a way that their gaps g are aligned side by side. The conductive wiring patterns 24 are laid out so that they run alongside the gaps g. As shown in FIG. 8, a part of the bump 42 enters the gap g and is connected to the peripheral surface 37 of the pad 23.

When the printed circuit board 62 of this configuration is used, the bonded state of each bump 42 with a pad 23 is affected to a lesser extent by the sizes and number of conductive wiring patterns 24 connected to the pad 23, and a stable bonded state can be formed as a result. In other words, providing extension parts 34 on the pad 23 reduces the rate of change in the pad area due to the effect of any conductive wiring pattern 24 connected to the pad. This makes the bonded state of bump 42 roughly uniform among individual pads 23. According to the printed circuit board 62 conforming to this embodiment, conductive wiring patterns 24 are connected to extension parts 34 and therefore the area of each pad does not change due to the effect of any conductive wiring pattern 24 connected to it, and consequently a more uniform bonded state can be achieved.

In the layout design of this printed wiring board 63, pads 23 and conductive wiring patterns 24 are designed in separate processes, respectively. The pad 23 conforming to this embodiment has a plurality of extension parts 34 arranged all around the pad body 33 at an equal interval from each other. If this pad shape is used as a standard design, it can support various conductive wiring patterns 24. In other words, all that needs to be done in the layout design of a printed wiring board 63 is to design conductive wiring patterns 24 corresponding to the circuit component to be installed, and there is no need to design pads.

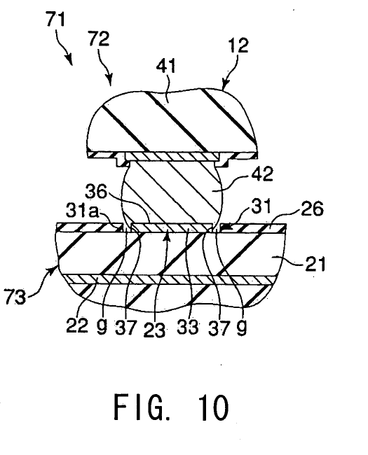

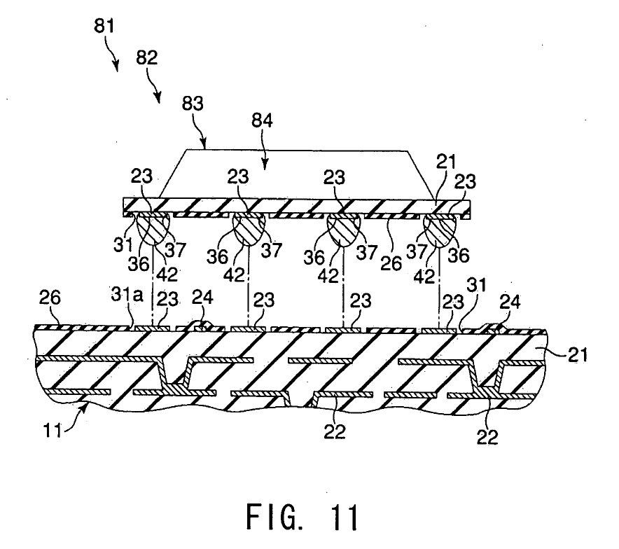

A portable computer 71 is explained by referring to FIGS. 9 and 10, as an electronic device conforming to the fourth embodiment of the present invention. The parts of configuration having the same functions as the corresponding parts of the portable computers 1, 61 conforming to the first and third embodiments are not explained, and they are indicated using the same symbols.

The enclosure 4 of the portable computer 71 houses a printed circuit board 72 inside. The printed circuit board 72 has a printed wiring board 73 and a circuit component 12 on which bumps 42 are provided. The printed wiring board 73 has a plurality of pads 23 provided on an insulating substrate 21. As shown in FIG. 9, the conductive wiring pattern 24 is connected to the pad body 33 of the pad 23. As shown in FIG. 10, a part of the bump 42 enters the gap g and is connected to the peripheral surface 37 of the pad 23.

When the printed circuit board 72 of this configuration is used, the bonded state of each bump 42 with a pad 23 is affected to a lesser extent by the sizes and number of conductive wiring patterns 24 connected to the pad 23. The pad 23 conforming to this embodiment changes its pad area when conductive wiring patterns 24 are connected to it. Even when the pad area changes as a result of connection of conductive wiring patterns 24, however, the pad 23 initially has a larger area by virtue of extension parts 34 and therefore the rate of change in the pad area is kept small. This makes the bonded state of bump 42 roughly uniform among individual pads 23.

The pad shape to which conductive wiring patterns 24 are connected via the pad body 33 is not at all limited to the shape of the pad 23 used in this embodiment. For example, conductive wiring patterns 24 can be connected to the pad body 33 of the pad 23 conforming to the first or second embodiment.

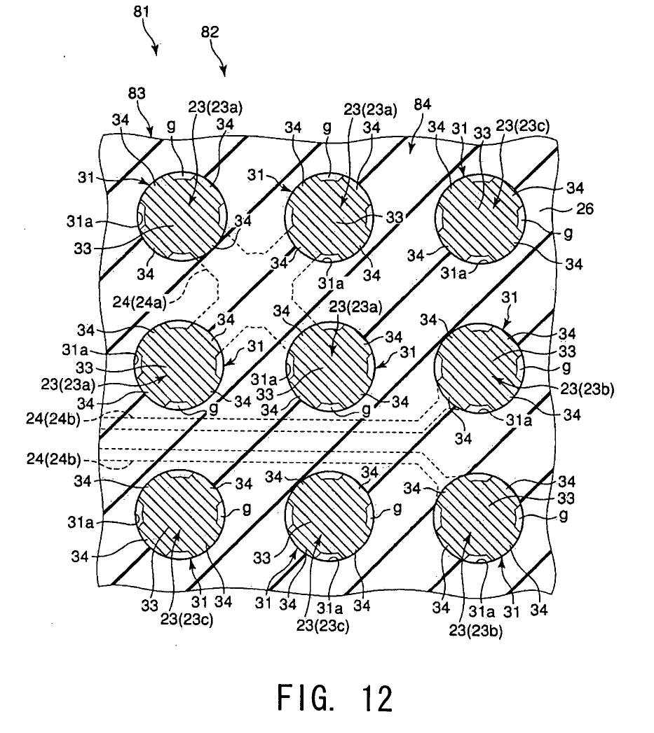

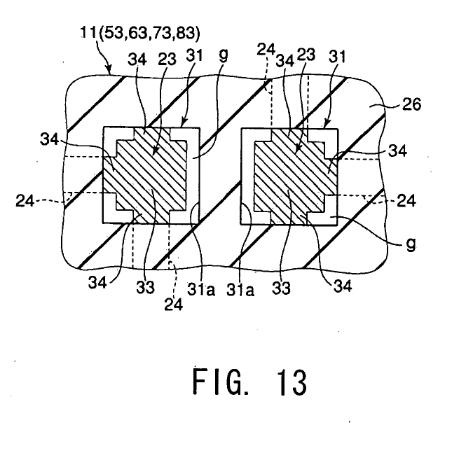

A portable computer 81 is explained by referring to FIGS. 11 and 12, as an electronic device conforming to the fifth embodiment of the present invention. The parts of configuration having the same functions as the corresponding parts of the portable computers 1, 61 conforming to the first and third embodiments are not explained, and they are indicated using the same symbols.

The enclosure 4 of the portable computer 81 houses a printed circuit board 82 inside. As shown in FIG. 11, the printed circuit board 82 has a printed wiring board 11 and a semiconductor package 83. The printed wiring board 11 may have pads of the shape conforming to the first embodiment, or it may be a printed wiring board that is commonly available on the market.

In this embodiment, explanation is given using a BGA package as an example of the semiconductor package 83. It should be noted, however, that the semiconductor package 83 is not at all limited to a BGA package, and a LGA or other package may also be used, for example. In other words, bumps 42 need not be attached to the semiconductor package, but they can also be provided on the printed wiring board.

The semiconductor package 83 has a package body 84. The package body 84 includes an insulating substrate 21, a plurality of pads 23, a plurality of conductive wiring patterns 24, and a solder resist 26.

As shown in FIG. 12, the pad 23 has a pad body 33 and an extension part 34. The total sum of the area of the pad body 33 of each pad 23 and the area of the pad's extension part 34 is the same among all pads 23. The first through third pads 23a, 23b, 23c conforming to this embodiment have four extension parts 34, 34, 34, 34, respectively. The total sum of the areas of the four extension parts 34 of each pad 23 is the same among all pads 23.

The pads 23 are arranged in such a way that their gaps g are aligned side by side. The conductive wiring patterns 24 are laid out so that they run alongside the gaps g. As shown in FIG. 11, a part of the bump 42 enters the gap g and is connected to the peripheral surface 37 of the pad 23.

The semiconductor package 83 is installed on the printed wiring board 11. Bumps 42 are provided on the bottom surface of the package body 84. The bumps 42 are connected to the pads 23 on the printed wiring board 11. As the bumps 42 are connected to the pads 23 on the printed wiring board 11, the semiconductor package 83 is electrically connected to the printed wiring board 11 via the bumps 42.

When the semiconductor package 83 of this configuration is used, the bonded state of each bump 42 with a pad 23 is affected to a lesser extent by the sizes and number of conductive wiring patterns 24 connected to the pad 23, and a stable bonded state can be formed as a result. In other words, providing extension parts 34 on the pad 23 reduces the rate of change in the pad area due to the effect of any conductive wiring pattern 24 connected to the pad. This makes the bonded state of bump 42 roughly uniform among individual pads 23. According to the semiconductor package 83 conforming to this embodiment, conductive wiring patterns 24 are connected to extension parts 34 and therefore the area of each pad does not change due to the effect of any conductive wiring pattern 24 connected to it, and consequently a more uniform bonded state can be achieved.

The pad shape of the semiconductor package 83 is not at all limited to the shape of the pad 23 used in this embodiment. For example, the shape of any of the pads provided on the printed wiring boards 11, 53, 73 that conform to the first, second and fourth embodiments may be adopted.

The above explained the portable computers 1, 51, 61, 71, 81 conforming to the first through fifth embodiments. It should be noted, however, that the embodiments of the present invention are not at all limited to these portable computers. The configuration conforming to each embodiment may be comprised of any combination of elements as deemed appropriate.

For example, the shape of the pad 23 need not be circular. For instance, a rectangular pad 23 like the one shown in FIG. 13 may be formed. The electronic devices to which the present invention is applicable are not at all limited to portable computers, but the present invention is also applicable to various other types of electronic devices such as mobile phones, digital cameras, video cameras and personal digital assistants.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A printed wiring board comprising:
an insulating substrate;
a plurality of lands formed on the insulating substrate;
a conductive wiring pattern coupled to the lands; and
a protective film covering the insulating substrate and having an opening for each land of the plurality of lands in a location corresponding to the applicable land, the opening for each land being larger than an outer profile of the land
wherein each of the plurality of lands comprises a land body separated by a gap from an opening rim of the opening, and an extension part extending from a portion of the land body to the opening rim of the opening over a portion of the gap.

2. A printed wiring board according to claim 1, wherein the conductive wiring pattern is connected to the extension part.

3. A printed wiring board according to claim 1, wherein the conductive wiring pattern is connected to the extension part and is lesser in width than the extension part.

4. A printed wiring board according to claim 1, wherein a total sum of the area of the land body of a first land of the plurality of lands and the area of the extension part of the first land is set to be the same as a total sum of the area of the land body of a second land of the plurality of lands and an area of the extension part of the second land.

5. A printed wiring board according to claim 1, wherein the plurality of lands are arranged so that the gaps provided between the land bodies and the opening rims of the respective lands are aligned side by side.

6. A printed wiring board according to claim 1, wherein the conductive wiring pattern is laid out so that each gap formed between the land body and the opening rim is disposed in a position between the land to which the conductive wiring pattern is connected and a different land to which the conductive wiring pattern is not connected.

7. A printed wiring board according to claim 1, wherein each of the plurality of lands includes a plurality of extension parts that are arranged in a manner separate from each other, and a sum of the areas of the plurality of extension parts associated with a first land of the plurality of lands is substantially equal to a sum of the areas of the extension parts of a second land of the plurality of lands.

8. A printed wiring board according to claim 7, wherein the plurality of extension parts are arranged to be equidistant from each other alongside the land body.

9. A printed wiring board according to claim 1 further comprising:
a plurality of bumps each bonded to a corresponding land of the plurality of lands; and
a circuit component including the plurality of bumps electrically connected and bonded to the corresponding land of the plurality of lands to form a printed circuit board.

10. A printed wiring board according to claim 9, wherein a part of each of the bumps enters the gap between the land body and the opening rim and is bonded to a peripheral surface of the land body.

11. A semiconductor package installed on a printed wiring board comprising:
an insulating substrate;
a plurality of lands formed on the insulating substrate and electrically coupled to the printed wiring board;
a conductive wiring pattern coupled to the lands; and
a protective film covering the insulating substrate and having a plurality of openings each being larger than an outer profile of a corresponding land of the plurality of lands,
wherein each of the plurality of lands includes a land body separated by a gap along an opening rim of an opening of the plurality of openings, and an extension part extending from a portion of the land body to the opening rim of the opening.

12. A semiconductor package according to claim 11, wherein the conductive wiring pattern is coupled to the extension part.

13. A semiconductor package according to claim 11 wherein a total sum of an area of the land body of each of the plurality of lands and an area of the extension part associated with each of the plurality of lands is equal to each other.

14. An electronic device comprising:
an enclosure;
an insulating substrate housed inside the enclosure;
a plurality of lands formed on the insulating substrate;
a conductive wiring pattern coupled to the plurality of lands;
a protective film covering portions of the insulating substrate, the protective film including a first opening sized greater than a first land of the plurality of lands and a second opening sized greater than a second land of the plurality of lands;
a plurality of bumps connected to the plurality of lands; and
a circuit component electrically connected to the plurality of lands via the plurality of bumps;
wherein a first land of the plurality of lands includes a land body separated from an opening rim of the first opening by a gap, and an extension part extending from a portion of the land body to the opening rim of the first opening over the gap.

15. An electronic device according to claim 14, wherein the conductive wiring pattern is connected to the extension part having a width greater than the conductive wiring pattern.

16. An electronic device according to claim 14, wherein a total sum of an area of the land body of the first land of the plurality of lands and an area of the extension part of the first land is set to be equal to a total sum of an area of the land body of the second land of the plurality of lands and an area of the extension part of the second land.

17. An electronic device according to claim 14, wherein the plurality of lands are arranged so that the gaps provided between the land bodies of the plurality of lands and the opening rims of the respective lands are aligned side by side.

18. An electronic device according to claim 14, wherein the conductive wiring pattern is laid out so that each gap formed between the land body and the opening rim of the first opening is disposed in a position between the land to which the conductive wiring pattern is connected and the second land to which the conductive wiring pattern is not connected.

19. An electronic device according to claim 14, wherein each of the plurality of lands includes a plurality of the extension parts that are arranged in a manner separate from each other, and a sum of areas of the plurality of extension parts for the first land of the plurality of lands is equal to a sum of areas of the extension parts for the second land of the plurality of lands.

20. An electronic device according to claim 19, wherein the plurality of extension parts of the first land are equidistant from each other alongside the land body.

21. A printed wiring board according to claim 1, wherein the land body is a pad and the extension part is conductive material extending over the gap at a single location to the opening rim of the opening.

22. A semiconductor according to claim 11, wherein each land body of each of the plurality of lands is a pad.

23. A printed wiring board according to claim 14, wherein the land body of the first land is a pad.
